(19) United States
(12) Patent Application Publication
(10) Pub. No.: US 2017/0116563 A1
(43) Pub. Date: Apr. 27, 2017

(54) System and Method for Arranging Duty with Transport Among Parties

(71) Applicant: Peter Fong, Arcadia, CA (US)

(72) Inventor: Peter Fong, Arcadia, CA (US)

(21) Appl. No.: 15/335,392

(22) Filed: Oct. 26, 2016

Related U.S. Application Data
(60) Provisional application No. 62/247,175, filed on Oct. 27, 2015.

(51) Int. Cl. G06Q 10/08; G06F 17/30; G06Q 30/02; H04L 29/08

(52) U.S. Cl. CPC G06Q 10/083; H04L 67/18; G06F 17/30864; G06Q 30/0265

(57) ABSTRACT

The present invention is a system and method for arranging duty with transport among parties, which method includes the steps of: enabling a customer at a first geographic location to access a database of a main service in order to select a duty and make a request for the duty, selecting a respondent at a second geographic location from a respondent pool of candidate respondents of the duty, communicating a progress information that contains the second geographic location to the customer, giving pay to the respondents after the respondents finished the duty for the customer, and collecting a first feedback from the customer and a second feedback from the respondents regarding the other party in the transaction.

### CROSS REFERENCE OF RELATED APPLICATION

This is a non-provisional application that claims priority to a provisional application, application No. 62/247,175, filed Oct. 27, 2015.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

Field of Invention

This invention relates to a computer implemented method and system, in particular, to a system and method for arranging duty with transport among parties through use of computing devices that are operated by the respective parties.

Description of Related Arts

We like Black Friday and Christmas, one of reasons is most retailers offering promotional sales. In these days, the price of the same product is lower than a normal day. But to express providers, they face a big challenge. In these days, the number of delivering package is much higher than the number of delivering package in normal day. It means that the express providers need more manpower to deliver package. Therefor, before the Black Friday, the express provides hire lots of temporary employees for Black Friday. After Black Friday, these temporary employees will be fired gradually. Because after Black Friday, the number of delivering packages reduces gradually, and finally, the number of delivering package returns to the average number of delivering package. To fire these temporary employees can be consider as a waste of resource. These temporary employees will receive a short-term training. During the Black Friday, these temporary employees practice what they learned from the short-term training. When these temporary be fired, these temporary employees are experienced, they are able to create more profit for the express providers. And this situation will come again and again. If some normal days, the number of the delivering package increases suddenly, these temporary employees are able to deal with the situation. But unfortunately, these temporary employees are fired.

If a package needs to be delivered, and a person passes through the starting location of the package and the destination of the package, then the person is able to deliver the package. But the package owner doesn't know the person is able to deliver the package, and the person doesn't know that the package needs to be delivered. To express providers, express providers don't know how to find the person who can help them to deliver package. But we don't have a place, which is capable of providing above information.

In modern society people rely on numerous services provided by others who should be compensated in diverse ways. Some service providers, such as barbers, taxi drivers, and accountant, charge when their services are provided. Other service providers almost only charge when a full service has been provided. For example, in real estate trading, most buyers and sellers make deals through agents because of several reasons, including that agents often have more flexible schedule and more updated knowledge about the neighborhood. However, a real estate agent typically provides demonstration and advice for free, but only receives compensation if he or she has made a deal, such as sold a consigned house. Similarly, car dealers and most contractors offer free services, including demonstrations, consultation, advice, inspection, and even transport, in order to win a final deal and obtain the compensation at once.

Although the latter way of charging looks economical to the potential customers of the services to estimate and compare possible costs of the services they are about to receive, several negative effects can also be therefore generated. For example, potential real estate buyers may somehow feel obligated or pressured to buy or to be bonded to one agent especially when the agent has been offering more and more demonstrations and suggestions for free. For another example, a used car dealer could tend to show only a few cars to his customer and push the customer to make decision based on those options because spending more time and efforts on showing more cars and sharing more knowledge of the cars do not benefit the dealer at all. That is, such “free service” way is not only harmful to the service providers by reducing their willingness and opportunity to collect more relative information and pathways for making a significant decision, such as buying a vehicle or real estate.

Besides, various service providers have been missing a great deal of potential customers because of transportation issues. Foreign customers and potential customers who lack of friendly transportation to the service providers can simply change their minds of approaching such services. Further, it may not be cost effective enough for the service providers to provide free rides for these customers. In order to attract these potential customers, service providers need to acquire a solution that brings more potential customers in and reduces their unpaid workload.

Lastly, once a service or duty was turned to be separately compensated, it creates a market and space for a third party to provide such service or duty independently. For example, an auto technician can become a third party agent for used car shopper, who brings customers to several used car dealers and help the customers to inspect the cars. Since this third party agent earn hourly pay rather than commission, he or she can pay more attention on the benefit of the customers and help the customers to make smarter decision. Meanwhile, the customers may not be just drawn in one or two stores by a few second party agents, but have more opportunity to follow the third party agent to visit more stores and compare more options before making the final decision.

### SUMMARY OF THE PRESENT INVENTION

The invention is advantageous in that it provides to a system for arranging duty with transport among parties, which create a platform that allows service providers to advertise thereon.

Another advantage of the invention is to provide to a system for arranging duty with transport among parties, which creates a platform that allows customers to request for services thereon.

Another advantage of the invention is to provide to a system for arranging duty with transport among parties, which creates a platform that organizes services thereon so as to help the users to identify services with relative background and detail information thereof.

Another advantage of the invention is to provide to a system for arranging duty with transport among parties, which is able to automatically match customer with service provider.

Another advantage of the invention is to provide to a system for arranging duty with transport among parties, which is able to automatically recommend service provider to customer.

Another advantage of the invention is to provide to a system for arranging duty with transport among parties, which is able to share information about the customer to a designated service provider.

Another advantage of the invention is to provide to a system for arranging duty with transport among parties, which is able to share information about service providers to a customer.

Another advantage of the invention is to provide to a system for arranging duty with transport among parties, which is able to share information about service providers to a customer.

Another advantage of the invention is to provide to a system for arranging duty with transport among parties, which allows service providers and customers to rate each other.

Another advantage of the invention is to provide to a system for arranging duty with transport among parties, which allows service providers and customers to make comment or feedback to each other.

Another advantage of the invention is to provide to a system for arranging duty with transport among parties, which is able to identify and record the locations of service providers and customers.

Another object of the present invention is to provide a system and method for arranging duty with transport among parties, which is able to make payment to service providers.

Another advantage of the invention is to provide to a system for arranging duty with transport among parties, creates a platform that allows customers to request for services thereon.

Another advantage of the invention is to provide to a system for arranging duty with transport among parties, which dispatches the request to the service provider.

Another advantage of the invention is to provide to a system for arranging service with transport among parties, which is capable of arranging service point.

Another advantage of the invention is to provide to a system for arranging service with transport among parties, which is capable of arranging transport service.

Another advantage of the invention is to provide to a system for arranging service with transport among parties, which is capable of arranging delivery goods.

Another advantage of the invention is to provide to a system for arranging service with transport among parties, which is capable of analyzing potential request information.

Another advantage of the invention is to provide to a system for arranging service with transport among parties, which is capable of rating the request information.

Another advantage of the invention is to provide to a system for arranging service with transport among parties, which is capable of rating the service information.

Another advantage of the invention is to provide to a system for arranging service with transport among parties, which dispatch the request information and the service information according to the rating of the request information and the rating of the request information.

Additional advantages and features of the invention will become apparent from the description, which follows, and may be realized by means of the instrumentalities and combinations particular point out in the appended claims.

Accordingly, in order to accomplish the above advantages and features, the present invention provides a system for arranging duty with transport among parties, which comprises a computing device operated by a customer, and one or more computing devices operated by one or more service providers, wherein each of the computing device comprise: a memory that store a set of instructions, a network component for enabling the computing device to wirelessly communicate through a network, a positioning component to determine a location of the computing device, a user interface to enable the computing device to receive input and generate output, and a processor connecting to the memory, the network component, the user interface, and the positioning component, wherein each computing device is configured by the set of instructions to:

enable the customer to operate the customer computing device in order to browse services and select a service with the user interface; enable the customer to further operate the customer computing device to request for service from a first geographic location; in response to the request of the customer, automatically generate a request for service by using the positioning component of the customer computing device to identify the first geographic location, and automatically including the first geographic location in the request for service; and communicate the request for service using the network component of the customer computing device, wherein each computing devices of the service provider is configured by the set of instructions to:

enable the service provider from a second geographic location to accept the request for service through operating the computing device with the user interface; using the positioning component to identify the second geographic location, and automatically including the second geographic location in a progress information; using the network component of the computing device of the service provider to send the progress information to the customer.

In accordance with another aspect of the invention, the present invention comprises of a method for arranging duty with transport among parties, includes the following steps:

(S1) enabling a customer at a first geographic location to select a service and make a request for the service;

(S2) selecting a service provider at a second geographic location from a pool of candidate service providers;

(S3) communicating the first geographic location to the service provider; and

(S4) communicating the second geographic location to the customer.

Still further objects and advantages will become apparent from a consideration of the ensuing description and drawings. These and other objectives, features, and advantages of the present invention will become apparent from the following detailed description, the accompanying drawings, and the appended claims.

### BRIEF DESCRIPTION OF THE DRAWINGS

FIG. 1 illustrates a system and method for arranging duty with transport between parties according to a preferred embodiment of the present invention

FIG. 2 illustrates a computing device that can be used by either customer or respondents to implement a system for arranging duty with transport between parties according to another preferred embodiment of the present invention.

FIG. 3 is a block diagram of a system for arranging duty with transport among parties according another preferred embodiment of the present invention, illustrating that the system structure of the system for arranging duty with transport among parties.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

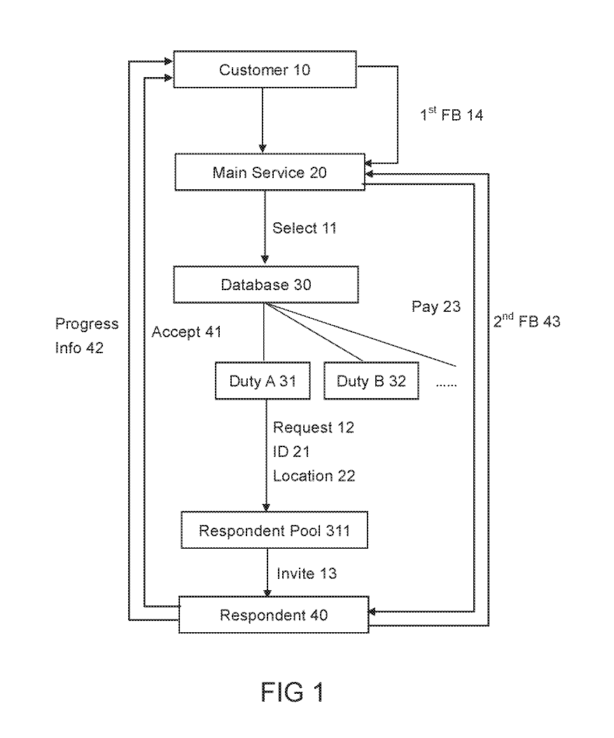

Referring to the drawings, FIG. 1 shows a system and method for arranging duty with transport between parties according to a first embodiment of the present invention. The method for arranging duty with transport between parties includes the following steps: (S1) enabling a customer 10 at a first geographic location to access a database 30 of the main service 20 in order to select a duty, such as duty A 31 (also referred to as ‘duty with transport’ or ‘service’) and make a request 12 for the duty, (S2) selecting a respondent 40 (also referred to as ‘respondent’ or ‘service provider’) at a second geographic location from a respondent pool 311 of candidate respondents 40 of the duty A 31, (S21) providing the identification 21 and the location 22 according to the first geographic location of the customer 10 to the candidate respondents 40 and enabling the candidate respondents 40 a limited time to accept 41 or decline the request 12 to take the duty A 31 for the customer 10, (S22) proceed to the next step if the candidate respondents 40 accepts the request 12, else repeating (S2) and (S21) for another candidate respondents 40 until a selected service provider accepts the request 12 to provide the service for the customer 10, (S4) communicating a progress information 42 that contains the second geographic location to the customer 10, (S5) giving pay 23 to the respondents 40 after the respondents 40 finished the duty A 31 for the customer 10, and (S6) collecting a first feedback 14 from the customer 10 and a second feedback 43 from the respondents 40 regarding the other party in the transaction.

The customer 10 can be an entity to use the present invention for the services/duties. The main service 20 can be a virtual service program form by and among numerous computing devices according to the present invention, a computing device according to the present invention, or an independent third party server or group of servers. The database 30 includes one or more sub-databases each for a duty (such as duty A 31, duty B 32, etc.) for the customer 10 to choose and use. A duty, such as duty A 31, can be any of the services, normally with transport, provided by an individual or business entity. For example, a duty can be to bring the customer into various real estates and provide corresponding information and advice, to drive the customer to visit the neighborhood around a real estate and provide general information thereabout, to send the customer to a clinic and provide health related advice, to bring and sit the customer's baby to a designated location, to nurse and drive for a senior customer, to protect and drive for a customer, to bring the customer to various store for buying a suitable gift, to drive and tour guide the customer in an area, to carry the customer with his/her car to the shop and repair the car, to bring the customer to houses owned or managed by the customer and estimate for the costs of remodeling, to drive the customers to various used car dealer and help the customer to inspect cars, to bring the customer to designated place and notarize matters there, or to bring the customer to various boutiques and hair salon and advice suitable styles to the customer. A duty usually involves two or more locations with extended needs of transport and jobs to be done. Also, a transport target can be either the customer or a third party, such as an infant, a senior, a VIP guest, a pet, or goods. Jobs besides transport of a duty can be simply offering suggestions, protecting, taking care of, helping to make decisions, estimating, repairing, healing, inspecting, shopping, demonstrating, accessing, keeping with, introducing, guiding, and more. Types of transport and job for a duty should not be limited within the above examples. A potential service provider or a respondent 40 is allowed to input his/her ad or background with a certain condition/type of service that he/she feels like to provide into the database 30 or the sub-database of the duties, so as to create and enrich the respondent pool 311 thereof.

The identification 21 may contain a brief history of feedback of the customer 10, so as to help a respondent 40 to decide if he/she is going to serve the customer 10. Similarly, the customer 10 can see a brief history of feedback of the respondent 40 before he/she was chosen. After each transaction, both the customer 10 and the respondent 40 may respectively use the first feedback 14 and the second feedback 43 to evaluate, rate, and/or comment to each other. Then the main service 20 will keeps these feedbacks for reference, in order to help the customer and the respondent to choose each other or to be automatically match/recommend to each other/a particular party by the main service 20.

The location 22 of service can also be a third geographic location that was designated by the customer or the respondent, which also allows and helps both parties to schedule a service for a later time or routinely rather than to directly proceed for the service shortly.

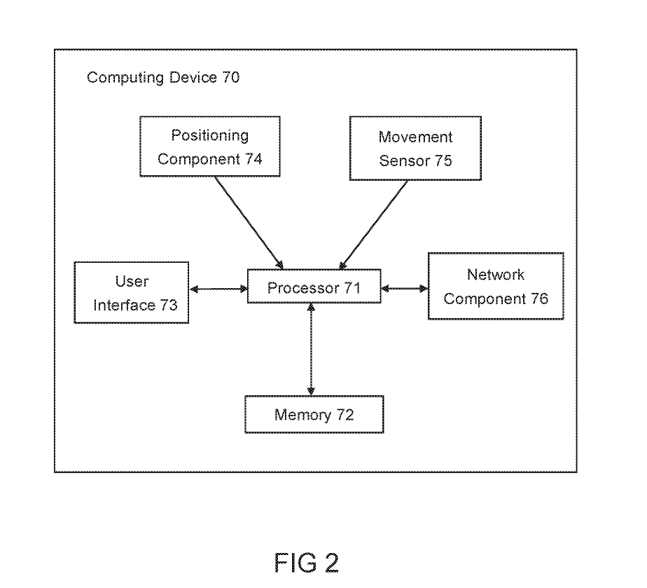

Next, a system for arranging duty with transport between parties according to a second embodiment of the present invention comprises a computing device 70 operated by a customer 10, and one or more computing devices 70 operated by one or more service providers/respondents 40, wherein each of the computing device 70, referring to FIG. 2, comprise: a memory 72 that store a set of instructions, a network component 76 for enabling the computing device 70 to wirelessly communicate through a network, a positioning component 74 to determine a location of the computing device 70, a user interface 73 to enable the computing device 70 to receive input and generate output, a movement sensor 75 to detect movements of the computing device 70, and a processor 71 connecting to the memory 72, the network component 76, the user interface 73, the movement sensor 75, and the positioning component 74.

The set of instructions stored in the memory 72 comprises: (i) enabling the customer 10 to operate the customer computing device in order to browse services/duties and to select a service/duty with the user interface 73, (ii) enabling the customer 10 to further operate the customer computing device to request for service from a first geographic location, (iii) in response to the request 12 of the customer 10, automatically generating a request for service by using the positioning component of the customer computing device to identify the first geographic location, and automatically including the first geographic location in the request for service, and (iv) communicating the request for service using the network component 76 of the custombcv er computing device.

Meanwhile each computing devices 70 of the service provider/respondent 40 is configured by the set of instructions comprises: (a) enabling the respondent 40 from a second geographic location to accept the request for service through operating the computing device 70 with the user interface 73, (b) using the positioning component to identify the second geographic location, and automatically including the second geographic location in a progress information 42, (c) using the network component 76 of the computing device 70 of the respondent 40 to send the progress information 42 to the customer 10.

The computing device 70 can be any computer, PDA, tablet, smart phone, laptop, netbook, or the like which conforms to the instructions that is able to perform the method or to be the system according to the present invention. The memory 72 can be a hard disk, a flash drive, a rewritable disc with reader, a non-volatile memory device, a combination of above, or the like. The network component 76 can be a wife device, a 3G device, a 4G device, a Bluetooth device, a radio device, a near field communication device, a GSM device, a CDMA device, a WiMAX device, a combination of above, or the like with adaptable and necessary communication resources, such as a 4G network. The positioning component 74 is a positioning signal receiving and processing device with at least one corresponding positioning signal or system approval or available, which corresponding positioning signal or system can be either the Global Navigation Satellite System (GNSS), the Global Positioning System (GPS), the GLONASS, the Galileo, the Indian Regional Navigation, the Satellite System (IRNSS), the BeiDou, or a combination of the above. The user interface 73 is a combination of one r more devices for a human being to interact with the computing device 70, including a display screen, a keyboard, a mouse, a light pen, a touch screen, a microphone, a speaker, a camera, a motion detector, and the like. The movement sensor 75 is a device for detecting the movement, such as an accelerometer or the like. The movement sensor 75 helps the computing device 70 to sense and update the movement and location to the main service 20 and the customer 10. The processor 71 is one or more processing units for the computing device 70 to execute the instructions by connecting to and controlling the memory 72, the network component 76, the user interface 73, the movement sensor 75, and the positioning component 74.

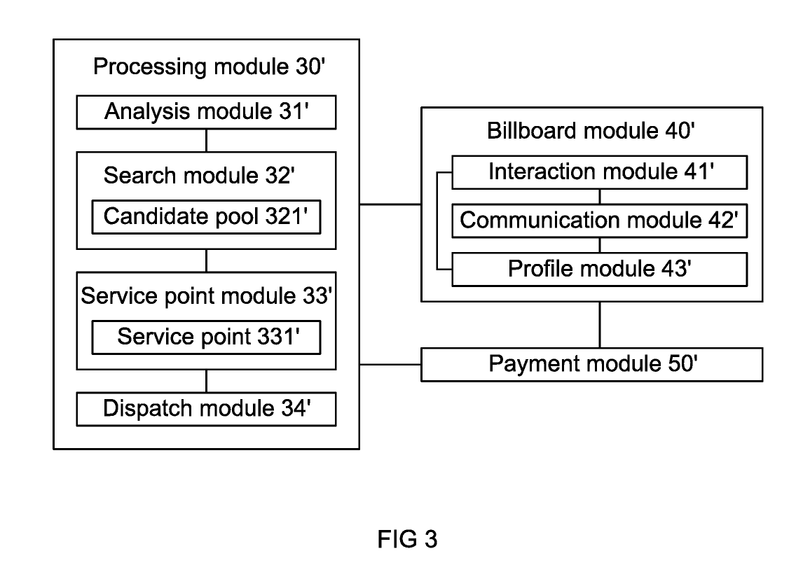

Referring to the drawing FIG. 3, a system for arranging service with transport among parties according to a preferred embodiment of the present invention is illustrated. The system for arranging service with transport among parties comprises a processing module 30′ and at least a billboard module 40′. The processing module 30′ communicatively connects with the billboard module 40′. The billboard module 40′ provides interaction between the requester and the respondent. More specifically, the requester makes a request through the billboard module 40′. In other words, the billboard module 40′ receives the request made by the requester. The processing module 30′ creates a candidate pool 321′ through analyzing the request made by the requester. The candidate pool 321′ comprises at least one candidate respondent. The candidate respondent refers to the respondent is satisfied with the request made by the requester. If the requester is the service provider, then the candidate respondent is the customer that the service provided by the service provider is satisfied with the request made by the customer. If the requester is the customer, then the candidate respondent is the service provider who provides the service that is satisfied with the request made by the customer. The billboard module 40′ provides the operation including inputting the information, editing the information, browsing the information, selecting the candidate respondent, and so on. It is worth mentioning that the processing module is capable of identifying the requester through the request made by the requester. If the requester makes the request regarding searching service, the requester is identified as the customer through the processing module 30′. If the requester makes the request regarding searching the customer, the requester is identified as the service provider through the processing module 30′. In other words, the processing module 30′ identifies the identity of the requester through analyzing the request made by the requester.

After the identity of the requester identified, the processing module 30′ further creates the candidate pool 321′. More specifically, the processing module 30′ further processing the request made by the requester for obtaining the request data. The processing module 30′ creates a candidate pool 321′ according to the request data. If the respondent is found, the respondent is added to the candidate pool 321′ through the processing module 30′. The requester selects the candidate respondent from the candidate pool 321′ through the billboard module 40′. For example, the service provider as the requester makes the request regarding transport service through the billboard module 40′. The processing module 30′ acquires the request regarding transport service from the billboard module 40′. The requester is identified as the service provider through the processing module 30′ analyzing the request regarding transport service. And the respondent is identified as the customer through the processing module 30′. The processing module creates the candidate pool 321′ according to the request regarding transport service. The processing module searches the customer in accordance with the request regarding transport service. If the customer who needs the transport service is found, the customer is added to the candidate pool 321′. For instance, the customer wants to deliver goods to the designated location. In other words, the customer searches for the transport service. The processing module 30′ finds the customer who wants to deliver goods to the designated location. The customer who wans to deliver goods to the designated location is added to candidate pool 321′. The service provider selects the customer who wants to deliver goods to the designated location from the candidate pool 321′ through the billboard module 40′. After the service provider selects the customer who wants to deliver goods to the designated location, the processing module 30′ arranges the service provider to serve the customer who wants to deliver goods to the designated location.

If the customer as the requester make the request regarding delivering goods to the designated location through the billboard module 40′, the processing module 30′ identifies the requester is the customer through analyzing the request regarding delivering goods to designated location. And the respondent is identified as the service provider through the processing module 30′ analyzing the request regarding delivering goods to the designated location. The processing module 30′ creates the candidate pool 321′ according to the request regarding delivering goods to the designated location. The processing module 30′ searches the service provider in accordance with the request regarding delivering goods to the designated location. If the service provider providing the transport service is found, the service provider is added to the candidate pool 321′. The customer selects the service provider providing transport service from the candidate pool 321′ through the billboard module 40′. After the customer selects the service provider providing transport service, the processing module 30′ arranges the service provider providing to serve the customer. Furthermore, the processing module 30′ arranges a service point 331′ for picking up goods and another service point 331′ for unloading the goods.

The processing module 30′ further comprises an analysis module 31′, a search module 32′ and a service point module 33′. The analysis module 31′ communicatively connects with the search module 32′ and the service point module 33′ separately. The analysis module 31′ communicatively connects with the billboard module 40′. The analysis module 31′ analyzes the request acquired from the billboard module 40′. The analysis module 31′ identifies the identity of the requester in accordance with the request made by the requester. In other words, the analysis module 31′ identifies the requester is the customer or the service provider according to the request made by the requester. The analysis module 31′ further analyzes the request for obtaining the request data. For example, the service provider makes the request regarding providing transport service from location A to location B through the billboard module 40′. Through analyzing the request regarding providing transport service from location A to location B, the analysis module 31′ identities the requester is service provider. In other words, the respondent is the customer. The analysis module 31′ obtains the request data through further analyzing the request regarding transport service from location A to location B. The request data comprises the request content is transport service, the start location of the transport service is location A and the destination is location B. Furthermore, the analysis module 31′ comprises the route of the transport service from location A to location B through analyzing the request regarding the transport service. The service data is sent to the search module 32′. The search module 32′ creates a candidate pool 321′ according to the request data. The search module 32′ further searches the customer that the transport service provided by the service provider is satisfied with the request of the customer. If the respondent is suitable to be served by the service provider, the respondent is added to the candidate pool 321′. In other words, if the transport service provided by the servicer provider is satisfied with the request of the customer, the customer is added to the candidate pool 321′. The customer of the candidate pool 321′ is considered as the candidate respondent. For example, the customer makes a request that delivering goods from location A to location B. The customer is added to the candidate pool 321′ through the search module 32′ after the customer is found.

The billboard module 40′ displays the customer acquired from the candidate pool 321′. If the service provider selecting one of the customers through the billboard module 40′, the request data of the service provider and the request of the customer are sent to the service point module 33′. The service point module 33′ arranges a service point 331′ for providing service. The service point module 33′ arranges the location A as the service point 331′ for picking up the goods and the location B as another service point 331′ for unloading the goods. The service point module 33′ sends the service point 331′ for picking up the goods and the service point 331′ for unloading the goods to the billboard module 40′. The billboard module 40′ is capable of displaying the feedback of the service status. After the service is finished, the service provider and the customer are capable of giving the feedback regarding the service, such as rating the service, commenting the service, rating the service provider, commenting the service provider, rating the customer and commenting the customer.

The service provider as the requester makes the request regarding providing transport service from location A to location B. Through analyzing the request regarding providing transport service from A to location B, the requester is identified as the service provider through the analysis module 31′, and the request data is obtained through the analysis module 32. If the service provider is moving to the designed location, the billboard module 40′ is capable of acquiring the current location of the service provider. The search module 32′ creates the candidate pool 321′ according to the request data. The search module 32′ searches the customer in accordance with the request data and based on the current location of the service provider. The current location is considered as the center of the circle, and the service provider further configures the search radius through the billboard module 40′. After the center of the circle and the search radius are configured, the range of searching is confirmed. The search module 32′ searches the customer who wanting to delivery goods to the designed location in the range of searching. If the search module 32′ finds the customer who wanting to delivery the package to the designed location, the customer who wanting to delivery goods to the designed location is added to the candidate pool 321′. The billboard module 40′ acquires the customer information from the candidate pool 321′. The billboard module 40′ shows the customer information so as to the service provider is capable of selecting the customer. If the service provider selects the customer, the service provider moves to the current location of the customer for picking up the goods. More specifically, after the service provider selecting the customer, the search module 32′ sends the current location of the service provider, the current location of the customer and the designed location to the service point module 33′. The service point module 33′ arranges the service point 331′ for picking up the goods. Preferably, the service point module 33′ arranges the location of the customer as the service point 331′ for picking up the goods, and the designed location as the service point 331′ for unloading the goods. Preferably, the service point 331′ is configured along the route of the transport service.

Furthermore, if the route of the transport service is configured, the service point module 33′ analyzes the route of the transport service to find which location is suitable for being configured as the service point 331′. In other words, if the location is suitable for picking up the goods or unloading the goods, the location is configured as the service point 331′ through the service point module 33′. It is worth mentioning that the service point 331′ is capable of configured a plurality of service points 331 along the route of the transport service. After the service points 331 along the route of the transport service is configured, each service point 331′ is configured as the center of the circle through the service point module 33′. In other words, the search module 32′ is capable of configuring a plurality of range of searching based on each service points. If the customer who wanting to delivery goods to the designated location is found in the range of searching, the customer who wanting to delivery goods to the designated location is added to the candidate pool 321′ through the search module 32′.

It is worth mentioning that the route of the transport service is capable of being adjusted. After at least one service point 33 is arranged, the route of the transport service is divided into at least two sub-routes through the service point module 33′. The service point module 33′ configures the range of adjustment. The sub-route between the current location of the service provider and the nearest service point 331′ is configured as the range of the adjustment. If the default range of adjustment cannot be adjustment, the service point module 33′ expands the range of the adjustment. The range of the adjustment is expanded to the next sub-route between the nearest service point 331′ and the next service point 331′. If the expanded range of adjustment is adjusted, the service point module 33′ stops adjusting. If the expanded range of adjustment cannot be adjusted, the service point 331′ continues to expand the range of adjustment, until the range of adjustment including the entire route of the transport service. It is worth mentioning that if the range of adjustment is expanded, the service point 331′ in the range of adjustment is capable of being adjusted.

If the customer is found in the range of searching based on the current location of service provider, the service point module 33′ arranges the current location of customer as the service point 331′. The service point module 33′ adjusts the sub-routes in the range of adjustment. If the customer is found in the range of reaching based on the service point 331′, the search module 33 informs the customer to place the goods at the service point 331′. The search module 33 further informs customer the ETA (Estimated Time of Arrival) of the service provider. It is worth mentioning that when the search module 32′ searches the customer, the search module 32′ estimates the ETA of the customer. If the customer who cannot arrive the service point 331′ before the service provider arrive, the customer doesn't be added to the candidate pool 321′.

The customer is capable of making the request through the billboard module 40′. The analysis module 31′ acquires request from the billboard module 40′. The analysis module 31′ analyzes the request for obtaining the request data, such as the request content, the deadline of the request, and the location of the request. For example, through the billboard module 40′, the customer makes the request that delivery the goods to location C, and the goods need to be arrived location C before 8 p.m. The analysis module 31′ acquires the request from the billboard module 40′. The analysis module 31′ analyzes the request to obtain the request data that the request content is delivery the package to location C, the deadline of the request is before 8 p.m. The request data is sent to the search module 32′. The billboard module 40′ sends the current location to the search module 32′. The search module 32′ searches the service provider according to the request data and/or the current location of the customer. The current location of the customer is configured as the search center. The customer configures the search radius through the billboard module 40′. The search module 32′ searches the service provider according to the current location of the customer. The search module 32′ further searches the service provider who providing transport service. The search module 32′ searches the service provider who is capable of delivering the goods to location C. And then the search module 32′ searches the service provider who is capable of delivering the goods to location C, and the package is arrived before 8 p.m. If the search module 32′ cannot find the service provider near the current location of the customer, the search module 32′ searches the service provider who passing through the current location of the customer and delivering the goods to the location C. According to the information of service point 331′, the search module 32′ is capable of acquiring the corresponding service information. The search module 32′ further searches the service point 331′ where the corresponding service provider picking up or delivering the goods to location C before 8 p.m. After the customer selecting the corresponding service provider, the search module 32′ informs the ETA of the corresponding service provider to the customer. The customer places the package at service point 331′ before the ETA of the corresponding service provider.

The billboard module 40′ is capable of being installed in the intelligent terminal as an independent application. The intelligent terminal comprises computer, laptop, tablet computer, laptop, tablet computer, wearable devices, intelligent vehicle intelligent phone and so on. The billboard module 40′ communicates with the other billboard modules 40. In other words, through the billboard module 40′, the customer is capable of interacting with the service provider. The billboard module 40′ is capable of acquiring information from the intelligent terminal.

The billboard module 40′ further comprises an interaction module 41′ and a communication module 42′. The interaction module 41′ communicatively connects with the communication module 42′. The interaction module 41′ communicatively connects with the intelligent terminal. The interaction module 41′ is capable of acquiring the information form the intelligent terminal. Preferably, before the billboard module 40′ acquires the information from the intelligent terminal, the billboard module 40′ needs to be approved for acquiring the information. The communication module 42′ communicatively with the processing module 30′. The interaction module 41′ provides to share information. More specifically, the requester makes the request through the interaction module 41′. The analysis module 31′ acquires the request through the communication module 42′. The analysis module 31′ identified the identity of the requester. The analysis module 31′ further analyzes the request to obtain the corresponding request data. The corresponding request data is sent to the search module 32′. The search module 32′ creates the candidate pool 321′ according to the corresponding request data. The search module 32′ searches the respondent according to the corresponding request data. If the search module 32′ finds the respondent in accordance with the corresponding request data. The respondent is added to the candidate pool 321′ through the search module 32′. The candidate pool 321′ is sent to the interaction module 41′ through the communication module 42′. The requester selects the candidate respondent from the candidate pool 321′ through the interaction module 41′.

For example, the service provider as the requester makes the request regarding the service information through the interaction module 41′. The analysis module 31′ acquires the request regarding the service information from the interaction module 41′ through the communication module 42′. The analysis module 31′ identifies the identity of the requester according to the request regarding the service information. The identity of the requester is the service provider through analyzing the request regarding the service information by the analysis module 31′. The analysis module 31′ analyzes the request regarding with the service information to obtain the corresponding request data. The search module 32′ is capable of creating the candidate pool 321′ through searching the respondent in accordance with the corresponding request data. If the customer as the respondent is found, the customer is added to the candidate pool 321′ through the search module 32′. The candidate pool 321′ is sent to the interaction module 41′ through the communication module 42′. The service provider selects the customer from the candidate pool 321′ through the interaction module 41′.

The billboard module 40′ further comprises a profile module 43′. The profile module 43′ communicatively connects with the interaction module 41′ and communication module 42′ separately. The profile module 43′ manages the user information. The user information includes the basic information and the historical information. The user information records the background of the user, the user's skill and so on. In other words, the basic information provides the information regarding what kind of service provided by the service provider. The historical information records the historical request information and/or historical service information. The user is considered as the customer when the user makes the request information regarding searching service provider through the interaction module 41′. The user is considered as the service provider when the user makes the request regarding the service information through the interaction module 41′. The profile module 43′ is capable of providing the historical information to the search module 32′. The historical information is capable of helping the search module 32′ to search. It is worth mentioning that after the service is finished, the customer is capable of rating and/or commenting the service provider about the service served by the service provider. The service provider is capable of rating and/or commenting the customer served by the service provider.

The system for arranging service with transport among parties of the present invention further comprises a payment module 50′. Through the payment module 50′, the customer pays the fee of service for the service provider. The payment module 50′ communicatively connects with the processing module 30′ and the billboard module 40′ separately. It is worth mentioning that the historical information including the payment history. In other words, the payment is recorded in the historical information of the customer and the historical of the service provider.

It is worth mentioning that the analysis module 31′ is capable of analyzing the additional request of the customer. More specifically, the customer makes the request regarding delivery goods through the interaction module 31. The analysis module 31′ analyzes the request regarding delivery goods and obtains the request dat. The analysis module 31′ acquires the historical information of the customer from the profile module 43′. The analysis module 31′ further analyzes the historical information regarding delivery goods of the customer. According to the historical information regarding delivery goods of the customer, the analysis module 31′ obtains the additional service provided by other service providers according to the request information of delivery goods of the customer. In other words, the customer makes addition requests, such as packing goods, storing goods. The analysis module 31′ sends the additional requests to the interaction module 41′. The addition requests are displayed through the interaction module 41′. After the service provider notices the additional request of the customer, the service provider is capable of preparing the service for the additional request.

For example, the customer makes the request regarding delivering goods through the interaction module 41′. The analysis module 31′ analyzes the request regarding delivering goods and obtains the request data including the quantity of goods, the starting location, the destination, the time of arrival, and so on. The analysis module 31′ further analyzes the request data and the historical information regarding delivering good of the customer to search the additional request. If the additional request is found, the additional request is displayed through the interaction module 31. The search module 32′ searches the service provider according to the request data and the additional request. Preferably, the search module 32′ searches the service provider who is capable of providing the services that are satisfied with the request information and the additional request made by the service provider. In this example, the customer the additional request is packing goods. In other words, the search module 32′ searches the service provider who is capable of providing the services of delivering goods and the packing goods. If the search module 32′ doesn't find the service provider who providing the services of delivering goods and the packing goods, the search module 32′ searches the service provider providing the service provider who providing the service of delivering goods and another service provider who providing the service of packing goods. Preferably, the location of the service provider providing the service of delivering goods and another service provider providing the service of packing goods are provided to the service point module 33′. The service point module 33′ analyzes the location of the customer, the location of the service provider providing the service of delivering goods, the location of the service provider providing the service of packing goods. The service point 33′ arranges the service points 331′ for the customer, the service provider providing the service of delivering goods and the service provider providing the service of packing goods. Preferably, the service points 331′ arranges one of the service points 331′ for the service provider providing the service of packing goods, so that the service provider providing the service of delivering goods is capable of transporting the service provider providing the packing goods to another service point 311′ for unloading goods. It is worth mentioning that if the goods cannot be delivered at a time, the search module 32′ searches a plurality of service provider providing the service of delivering goods for the customer, so that the goods is capable of being delivered at a time. The service point module 33′ arranges the time of arrival of the service point 331′ for each service providers providing the service of delivering goods, so that congestion of the service point 331′ for picking up the goods is avoided. The customer pays the service fee to each service provider through the payment module 50′.

If the customer makes the request regarding visiting real state through the interaction module 41′. The interaction module 41′ is capable of providing the current location of the customer to the processing module 30′. The analysis module 31′ acquires the request regarding visiting real state from the interaction module 41′. The analysis module 31′ analyzes the request regarding visiting real state and obtains the request data including the location of the real state, the time of visiting real state, and so on. The analysis module 31′ obtains the additional request through further analyzing the request data and the historical information. The analysis module 31′ analyzes the current location of the customer and the location of the real state. If the current location of the customer and the location of the real state aren't the same location, the additional request is a transport service from the current location of the customer to the location of the real state. If the analysis module 31′ obtains some historical information about visiting real states that the customer visits several real states at a time, the addition request is providing advice regarding the corresponding real state through the analysis module 31′. In other words, the customer needs the service of providing advice corresponding the real state, and the service of transport.

It is worth mentioning that the analysis module 31′ is capable of the service provider is capable of configuring the addition service through the interaction module 41′. In other words, the service provider configures which service is basic service and which service is additional service through the interaction module 31′. The customer pays fee according to the services provided by service provider.

The processing module 30′ further comprises a dispatch module 34′. The dispatch module 34′ dispatches the service provider to the customer if the service provided by the service provider is satisfied with the request of the customer. The dispatch module 34′ dispatches the customer to the service provider if the service provided by the service provider is satisfied with the request of the customer. Furthermore the dispatch module 34′ evaluates the request of the customer and the service provided by the service provider separately. For example, the dispatch module 34′ evaluates the request according to the distance of the transport service, the quantity of the goods, the feedback regarding the customer, the estimate profit, and so on. The dispatch module 34′ evaluates the service provided by service provider according to the service point 331′ of picking up goods, the ETA of the service point 331′ of picking up goods, the ETA of the designated location, the feedback regarding the service provider, the estimate fee for the service, and so on. If the request of the customer is capable of being serviced by at least two service providers, the dispatch module 34′ further acquires the user information of the customer, the user information of each service provider. The dispatch module 34′ dispatches the service provider who is the highest value evaluated by the dispatch module 34′ to the customer. If the service provided by the service provider is satisfied with at least two customers, the dispatch module 34′ dispatches the customer who is the highest value evaluated by the dispatch module 34′ to the service provider.

It is worth mentioning that the user information of the customer and/or the user information of the service information are capable of assisting the dispatch module 34′ to dispatch. For example, the customer E makes the request regarding delivering package from location A to location B through the interaction module 41′. The customer F makes the request regarding delivering package from location C to location D through the interaction module 41′. The service provider G provides the service information regarding the transport service that is satisfied with the request of the customer A and the request of the customer B. The service provider H provides the service information regarding the transport service that is stratified with the request of the customer A and the request of the customer B. The dispatch module 34′ dispatches the request to the service provider in accordance with the request regarding delivering package from location A to location B made by the customer E, the request regarding delivering package from location C to location F made by the customer F, the service information regarding the transport service provided by the service provider G, the service information regarding the transport servicer provided by the service provider H, the user information of the customer E, the user information of the customer F, the user information of the service provider G, the user information of the service provider H, and the user information of the service provider I.

More specifically, the dispatch module 34′ evaluates the request of the customer and the service information provided by the service provider separately. If the distance of delivering package is longer, the dispatch module 40 evaluates the value of the request information higher. If the rating of the customer is higher, the dispatch module 40 evaluates the value of the request information higher. If the estimate profit from the request of the customer is higher, the dispatch module 34′ evaluates value of the request information higher. The distance between location A to location B is longer than the distance between location C to location D, so the dispatch module 34′ evaluates the value of the request information of the customer E is higher than the value of the request information of the customer F. The rating of the customer E is higher than the rating of the customer F, so the dispatch module 34′ evaluates the value of the request information the customer E is higher than the value of the request information of the customer F. The estimation profit that the request information of the customer E is satisfied is higher than the estimation profit that the request information of the customer F, so the dispatch module 34′ evaluates the value of the request information of the customer E is higher than the value of the request information of the customer F. After analyzing the distance between two location, the rating of the customer, and the estimation profit, the dispatch module 34′ evaluates the value of the request of the customer E is higher than the value of the request of the customer F.

If the service point of picking up package of the service provider G is nearer than the service point 333 of picking up package of the service provider H, the dispatch module 34′ evaluates the value of the service information provider provided by the service provider G is higher than the value of the service information provided by the service provider H. If the ETA of the service point 333 of the service information provided by the service provider G is less than the ETA of the service point 333 of the service information provided by the service provider H, the dispatch module 34′ evaluates the value of the service information provided by the service provider G is higher than the value of the service information provided by the service provider H. If the rating of the service provider G is higher than the rating of the service provider H, the dispatch module 34′ evaluates the value of the service information provided by the service provider G is higher than the service information provided by the service provider H. After the dispatch module 34′ analyzes the service point 333 of picking up package, the ETA of the service points 333, the rating of the service provider, the dispatch module 34′ evaluates the value of the service information provided by the service provider G is higher than the service information provided by the service provider H.

The dispatch module 34′ further analyzes the user information of the customer E, the user information of the customer F, the user information of the service provider G, the user information of the service provider I for obtaining the average value that the customer rating the service provider, the average value that the service provider rating the customer, the rating of the customer, and the rating of the service provider. The dispatch module 34′ is capable of being configured the analysis range. Preferably, the default analysis range is configured as the last five times. The dispatch module 34′ compares the average value that the customer rating the service provider. If the customer gets high rating, which means that the customer is a good customer. If the service provider gets high rating, which means that the service provider provides good service. If the average value that the customer rating the service provider is lower, which means the customer receiving the quantity of high value of service is less. The dispatch module 34′ dispatches the high value of the service to the customer. If the average value that server provider rating the customer is lower, which means the server provider serving the quantity of high value customer is less. The dispatch module 34′ dispatches the high value of the customer to the service provider.

It is worth mentioning that the dispatch module 34′ further dispatches the request information to the service according to the estimated profit. The dispatch module 34′ further analyzes the average profit in the analysis range. If the average profit of the service provider is lower, the dispatch module 34′ dispatches the higher estimated profit of the request information to the service provider who receiving the lower average profit in the analysis range. If the average profit of the service provider is higher, the dispatch module 34′ dispatches the lower estimated profit of the request information to service provider who receiving the higher average profit in the analysis range. In this way, the service provider is capable of being dispatched the various customers, and the customer is capable of be severed by various service providers. Furthermore, if the average profit of the service provider is lower, the dispatch module 34′ dispatches the higher estimated profit of the request information to the service provider. The profit of service provider is capable of being maintain a balanced status, so that the service provider keeps using the system for arranging service with transport among parties of the present invention. The customer is capable of being served by high rating service provider, so that the customer is capable of being used the system for arranging service with transport among parties of the present invention for long time. In other words, through the dispatch module 34′ dispatching, the customer and the service provider are capable of being maintained using the system for arrange service with transport among parties of the present invention.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method for arranging duty with transport among parties, comprising the steps, executed by a computer, of:
(a) receiving a request for a duty from a customer as a first party when the customer at a first geographic location accesses a database of a main service in order to select the duty and make the request for the duty, wherein the customer must input a description of the duty in the request;
(b) receiving an accept for the duty from a respondent as a second party at a second geographic location;
(c) sending out a progress information to the customer; and
(d) collecting a first feedback from the customer and a second feedback from the respondent after the respondent finished the duty.

2. The method, as recited in claim 1, wherein, in the step (a), the customer selects the respondent from a respondent pool of candidate respondents of the duty.

3. The method, as recited in claim 2, wherein the step (a) further comprises the steps of:
(a.1) providing an identification and a location according to the first geographic location of the customer to the candidate respondents and enabling the candidate respondent to accept or decline the request within a limited time to take the duty for the customer; and
(a.2) if the candidate respondent declines the request, selecting another candidate respondent until one of the candidate respondents accepts the request.

4. The method, as recited in claim 3, wherein the identification contains a history of first feedback from the customer and the second feedback from the respondent for evaluation.

5. The method, as recited in claim 1, wherein the step (d) further comprises a step of paying the respondent by the customer after the respondent finished the duty.

6. The method, as recited in claim 1, wherein each of the customer and the respondent communicate to the main service via a computing device.

7. The method, as recited in claim 5, wherein each of the customer and the respondent communicate to the main service via a computing device.

8. The method, as recited in claim 6, wherein the computing device automatically obtains the first geographic location of the customer when the request is received.

9. The method, as recited in claim 7, wherein the computing device automatically obtains the first geographic location of the customer when the request is received.

10. The method, as recited in claim 9, further comprising a step of sending an updated location of the customer to the main service.

11. A system for arranging duty with transport among parties, comprising:
a main service which comprises a database containing a plurality of different duties;
a plurality of customer computing devices wirelessly linked to the main service, wherein the main service receives a request for the duty via one of the customer computing devices from a customer as a first party when the customer at a first geographic location accesses the database of the main service in order to select one of the duties and make the request for the duty, wherein a description of the duty in the request must be input by the customer; and
a plurality of respondent computing devices wirelessly linked to the main service, wherein the main service receives an accept for the duty via one of the respondent computing devices from a respondent as a second party at a second geographic location, wherein the main service sends out a progress information to the customer and collects a first feedback from the customer and a second feedback from the respondent after the respondent finished the duty.

12. The system, as recited in claim 11, wherein the main service further comprises a respondent pool of candidate respondents for the customer to select one of the candidate respondents in the respondent pool in the request for the duty.

13. The system, as recited in claim 12, wherein the main service provides an identification and a location according to the first geographic location of the customer to the candidate respondents and enables the candidate respondent to accept or decline the request within a limited time to take the duty for the customer, wherein if the candidate respondent declines the request, selecting another candidate respondent until one of the candidate respondents accepts the request.

14. The system, as recited in claim 13, wherein the identification contains a history of first feedback from the customer and the second feedback from the respondent for evaluation.

15. The system, as recited in claim 11, wherein each of the customer computing devices and the respondent computing devices comprises a positioning component that determines a location of the customer computing device and a location of the respondent computing device for automatically obtaining the first geographic location of the customer and the second geographic location of the respondent.

16. The system, as recited in claim 14, wherein each of the customer computing devices and the respondent computing devices comprises a positioning component that determines a location of the customer computing device and a location of the respondent computing device for automatically obtaining the first geographic location of the customer and the second geographic location of the respondent.

17. The system, as recited in claim 11, wherein each of the customer computing devices and the respondent computing devices comprises a movement sensor that determines a movement of the customer computing device and the respondent computing device for automatically updating locations of the customer and the respondent to the main service.

18. The system, as recited in claim 16, wherein each of the customer computing devices and the respondent computing devices comprises a movement sensor that determines a movement of the customer computing device and the respondent computing device for automatically updating locations of the customer and the respondent to the main service.

19. The system, as recited in claim 11, wherein the main service collects pay from the customer to the respondent after the respondent finished the duty.

20. The system, as recited in claim 18, wherein the main service collects pay from the customer to the respondent after the respondent finished the duty.

21. A system for arranging duty with transport among parties, comprising:
at least a billboard module for providing interaction between a requester and a respondent; and
a processing module, communicatively connecting with said billboard module, wherein said processing module searches the respondent according to a request made by the requester acquired from said billboard module, wherein after the respondent is confirmed, said processing module arranges an additional transport duty in accordance with a location of the requester, said request made by the requester, and said location of the respondent.

22. The system, as recites in claim 21, wherein said processing module further comprises:
an analysis module obtaining request data through analyzing said request made by the requester;
a search module searching the respondent according to said request data acquired from said analysis module; and
a service point module for arranging at least a service point for providing an additional transport duty in accordance with said request data acquired from said analysis module, said location of the requester acquired from said billboard module, and said location of the respondent acquired from said billboard module,

23. The system, as recites in claim 22, wherein the said search module creates a candidate pool for the requester selecting the respondent, wherein if said duty provided by the respondent is satisfied with said request made by the requester, the respondent is added to said candidate pool.

24. The system, as recites claim 22, wherein said billboard module further comprises:
an interaction module for providing interaction; and
a communication module, communicatively connecting with said analysis module, wherein said analysis module acquires said request made by the requester through said communication module.

25. The system, as recited in claim 24, wherein the billboard module further comprises a profile module, which communicatively connects with said interaction module and said communication module separately, wherein said profile module manages a user information.

26. A system for arranging duty with transport among parties, comprising a computing device operated by a customer, and one or more computing devices operated by one or more service providers, wherein each of the computing devices comprises:
a memory that stores a set of instructions;
a network component enabling said computing devices to wirelessly communicate through a network;
a positioning component, determining a location of each of said computing devices;
a user interface which enables said computing devices to receive input and generate output, and;
a processor connecting to said memory, said network component, said user interface, and said positioning component, wherein each of said computing devices is configured by a set of instructions to:
(i) enable said customer to operate said computing device of said customer in order to browse services and select a service with said user interface;
(ii) enable said customer to further operate said computing device of said customer to request for service from a first geographic location;
(iii) in response to said request of said computer device of said customer, automatically generate a request for service by using a positioning component of said computing device of said customer to identify said first geographic location, and automatically including said first geographic location in said request for service; and
(iv) communicate said request for service using said network component of said computing device of said customer, wherein each of said computing devices of said service provider is configured by said set of instructions to:
(a) enable said service provider from a second geographic location to accept said request for service through operating said computing device with said user interface;
(b) use said positioning component to identify said second geographic location, and automatically include said second geographic location in a progress information; and
(c) use said network component of said computing device of said service provider to send a progress information to said customer.

27. A method for arranging duty with transport among parties, comprising the steps of:
(A) enabling a customer at a first geographic location to access a database in order to select a duty and make a request for the duty;
(B) selecting a respondent at a second geographic location from a respondent pool of candidate respondents;
(C) communicating said first geographic location to said respondents; and
(D) communicating said second geographic location to said customer.

28. The method, as recited in claim 27, further comprising the steps of:
(E) communicating a progress information that contains said second geographic location to said customer;
(F) giving pay to said respondents after the respondents finished a duty for said customer; and
(G) collecting a first feedback from said customer and a second feedback from said respondents regarding the other party in a transaction.

29. The method, as recited in claim 28, after the step (B), further comprising the steps of:
(B1) providing an identification and a location according to said first geographic location of said customer to said candidate respondents and enabling said candidate respondents a limited time to accept or decline said request to take said duty for said customer; and
(B2) proceeding to the next step if said candidate respondents accept said request, else repeating said step (B) and said step (B1) for another candidate respondents until a selected service provider accepts said request to provide said service for said customer.

30. The method, as recited in claim 27, wherein said step (E) further comprises the steps of:
(E1) communicating a third geographic location designated by said customer to said respondents.
